(19) United States
(12) Patent Application Publication
(10) Pub. No.: US 2009/0278464 A1
(43) Pub. Date: Nov. 12, 2009

(54) Christmas light string combining tungsten lamps with LED lamps

(76) Inventor: Hung-Huei Chung, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/149,874

(22) Filed: May 9, 2008

(51) Int. Cl. H05B 37/02

(52) U.S. Cl. 315/185 S

(57) ABSTRACT

The present invention is to provide a kind of decoration light string structure combining of tungsten filament lamps and LED lamps, which is characterized in a decoration lamp string with single power plug and combining of wrapped tungsten filament lamp string and LED lamp string to form a curtain lamp configuration. The decoration light string is thus equipped with two kinds of light source effects of the traditional tungsten filament lamp and LED lamp.

### BACKGROUND OF THE INVENTION

We all know that the Christmas light string generally uses traditional tungsten lamp as its power source, and the LED lamp has been adopted as its power source in these years. The light sources used in these two kinds of lamps are different still less the advantages and disadvantages of these two kinds of lamps themselves. For the traditional tungsten filament lamp, its produced light source has the light flooding property and thus has better lighting effect. The light source produced in a LED lamp basically has the light concentration property and has the steady illumination effect of single spot as the sparkling star.

If we can combine these two kinds of lamp light sources and use them together, it definitely can produce the best light source effect in the Christmas light string. And, the current known application method is to separately plug the power sources for mixed hanging set in a lamp string combining of a lamp string using traditional tungsten filament lamps as its light source and a lamp string using LED lamps as its light source. However, this kind of set up is not very convenient while usage, and is vulnerably to create the problems while maintenance. Thus, it needs to be further improved.

### SUMMARY OF THE INVENTION

The present invention is related to an improvement in technology of the Christmas light string, and specially combines the traditional tungsten lamp with the LED lamp to form the decoration lamps using a single power plug. The structures of the present invention will be described hereafter by referring to the following drawings.

### BRIEF DESCRIPTION OF THE DRAWINGS

FIG. 1 is a structural assembling configuration drawing of the present invention.

FIG. 2 is an embodiment drawing of a structural assembling configuration in the present invention.

### DETAILED DESCRIPTION OF THE PREFERRED EMBODIMENT

The present invention is a kind of decoration light string structure combining of tungsten filament lamps and LED lamps. The said decoration lamp 10 includes main elements such as a tungsten filament lamp string 11, a LED lamp string 12 and a single power plug 20. The mount-set light source in the tungsten filament lamp string 11 is a traditional tungsten filament lamp 111, and the mount-set light source in the LED lamp string 12 is a LED lamp 121. The tungsten filament lamp string 11 and the LED lamp string 12 are all equipped with the power conductive leads 112, 122 of anodes and the power conductive leads 113, 123 of cathodes.

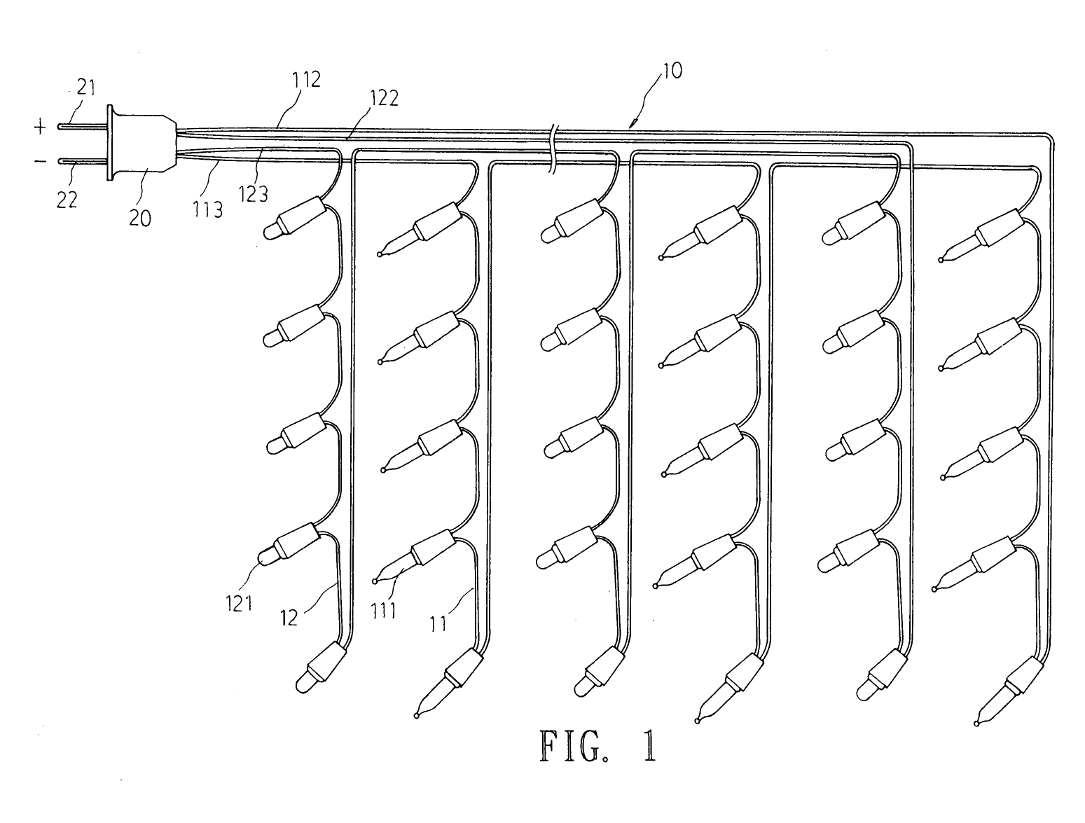

Please refer to those shown in FIG. 1. Firstly, the tungsten lamp string 11 and LED lamp string 12 are wrapped together to form a decoration lamp string 10 with the curtain lamp configuration, and each hanging strings of the curtain lamp can adopt an alternate link configure (single lamp hanging string) of a tungsten filament lamp string 11 and a LED lamp string 12. Secondly, it can also wrap the tungsten filament lamp string 11 and LED lamp string 12 together to form a dual lamp string configure (not shown in the figure), and each dual lamps are all combined of traditional tungsten filament lamps 111 and LED lamps 121 (it can also wrapped with 3, 4 or more hanging lamp strings together to form 3, 4 or more lamp string hanging configure by this application). Then the front ends of anode conductive power leads 112, 122 in the tungsten filament lamp string 11 and LED lamp string 12 are linked together with the end front of anode copper insert 21 in a plug 20, and the front ends of cathode conductive power leads 113, 123 in the tungsten filament lamp string 11 and LED lamp string 12 are linked together with the end front of a cathode copper insert 22 in a plug 20 to let the decoration light string 10 after linking use a single power plug 20 to provide the required power for conducting the tungsten filament lamp string 11 and LED lamp string 12 simultaneously. The decoration light string 10 thus can be equipped with two different light effects at the same time from the traditional tungsten filament lamp 111 and LED lamp 121.

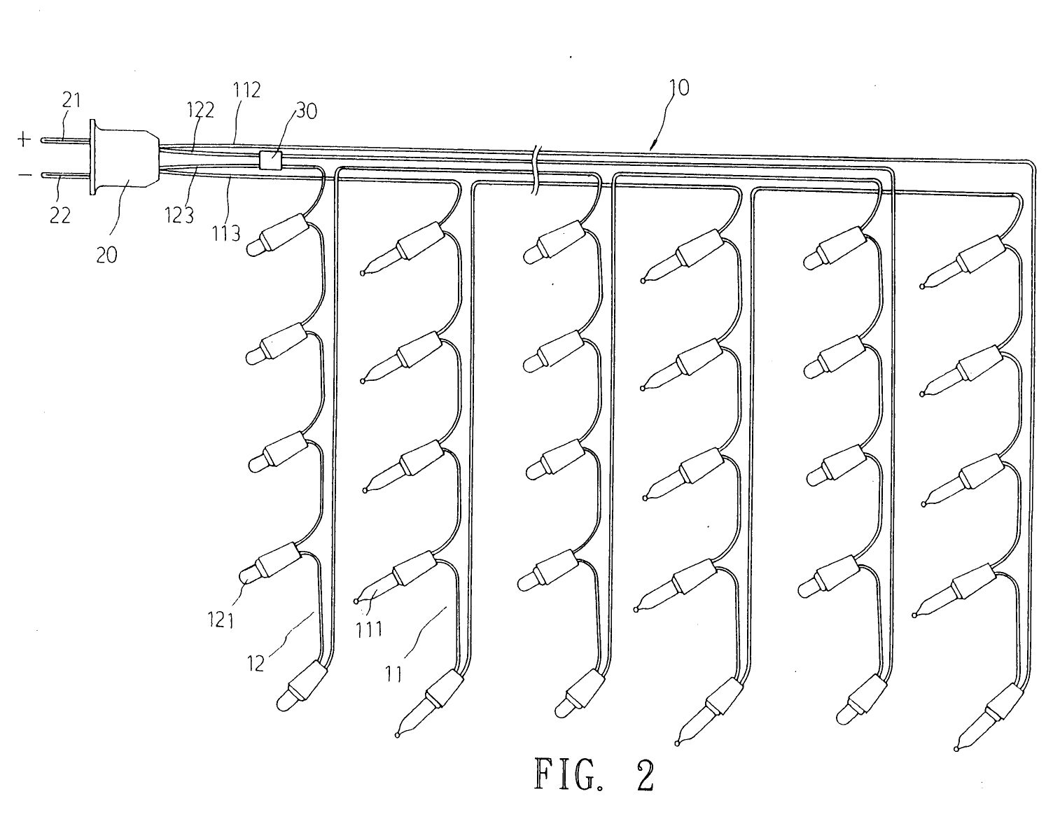

Please refer to those shown in FIG. 2. Due to the momentary blinking of light sources not sensible by human eyes while using the AC (Alternate current about 50 times per second) occurred in part of the currently used LED lamps 121, it will need to connect-set a voltage transforming rectifier 30 after the combining of anode and cathode power conductive leads 122, 123 in the LED lamp string 12 with the power plug 20 for the provision of required power current conforming with the need in LED lamps 121 to maintain the life of LED lamps 121 and their light sources' effects.

I claim:

1. A kind of decoration light string structure combining of tungsten filament lamps and LED lamps mainly including elements such as a filament lamp string, a LED lamp string and a single power plug, which is characterized in a single string of the decoration light string combining with wrapped tungsten filament lamp string and LED lamp string, wherein the power conductive leads of anodes of the tungsten filament lamp string and the LED lamp string are connected together with an anode copper insert in a power plug and the power conductive leads of cathodes of the tungsten filament lamp string and the LED lamp string are connected together with a cathode copper insert of in a power plug.

2. A kind of decoration light string structure combining of tungsten filament lamps and LED lamps as claimed in claim 1, wherein a voltage transforming rectifier is connected set after the combining of said anode and cathode power conductive leads in the LED lamp string with the power plug.
